(19) United States
(12) Patent Application Publication
(10) Pub. No.: US 2013/0216841 A1
(43) Pub. Date: Aug. 22, 2013

(54) ANTI-BACTERIAL TOUCH PANEL AND MANUFACTURING METHOD FOR THE SAME

(71) Applicant: CHIH-HAO HUANG, New Taipei (TW)

(72) Inventor: CHIH-HAO HUANG, New Taipei (TW)

(73) Assignee: Cheng Uei Precision Industry Co., LTD., New Taipei City (TW)

(21) Appl. No.: 13/400,571

(22) Filed: Feb. 21, 2012

(51) Int. Cl. B32B 17/06; B05D 1/02; B05D 3/12; B05D 5/00; B05D 1/18; B82Y 30/00

(52) U.S. Cl. 428/429; 427/58; 977/832

(57) ABSTRACT

The present invention discloses an anti-bacterial touch panel and a manufacturing method for the same. A silane coupling agent forms a bonding layer by way of a chemical bonding between a glass substrate of the anti-bacterial touch panel and an anti-bacterial layer which is made of nano-antibacterial materials. The total thickness of the anti-bacterial layer and the bonding layer on the anti-bacterial touch panel is of a molecular level, thus, the size and optical properties of the anti-bacterial touch panel will not be affected.

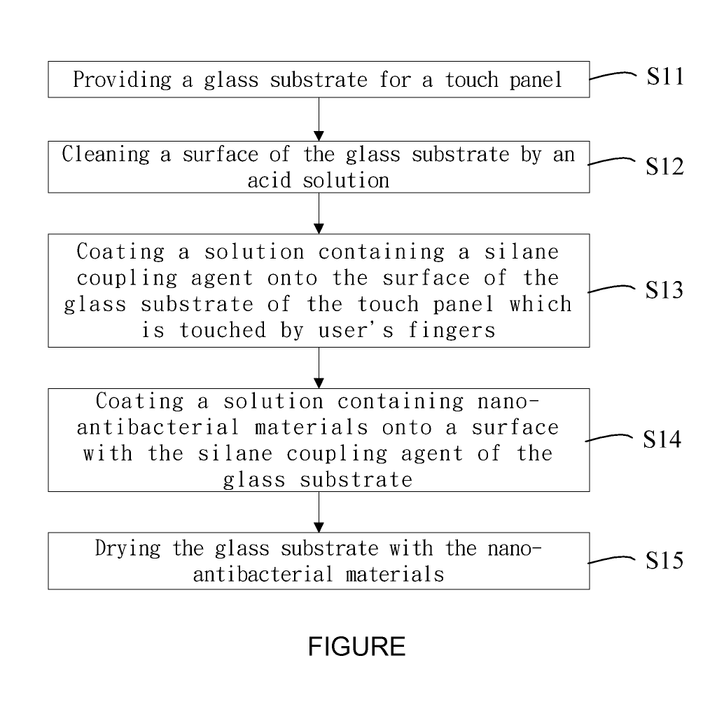

### BACKGROUND OF THE INVENTION

1. Field of the Invention

The present invention relates to a touch panel and a manufacturing method for the same, and more particularly, to an anti-bacterial touch panel which is utilized for inhibiting bacteria growth on the surface thereof.

2. Description of the Prior Art

There has been an exploded demand for touch panels in recent years, mainly due to the blooming of smart phone use. In addition to the smart phone has a demand for touch, products of operation by touch includes personal screen monitor, medical POS machine, digital camera, automated teller machine, information guidance system of public place, etc.

However, in addition to visible dust and dirt on a surface of a touch panel by operation of user, the surface has many invisible bacteria, wherein most common cultures of the bacteria includes Staphylococcus aureus, Escherichia coli, etc. If the user's fingers are contacted with the touch panel, and the bacteria are attached to the fingers. The user's body may be inflammation related to a bacterial infection via dietary behaviors or mucosal contact.

Conventional technologies disclose an anti-bacterial touch display device, wherein an anti-bacterial agent is adhered onto a surface of a support element by coating a buffer layer.

Based on the technologies above, at least one coating with an actual thickness is coated onto the surface of the touch panel. Thus, it not only increases volume of the touch panel, and it may be disadvantages to optical properties of the screen monitor.

### BRIEF SUMMARY OF THE INVENTION

The present invention provides an anti-bacterial touch panel and a manufacturing method for the same for improving a problem of a thicker coating of an anti-bacterial layer in the prior art.

An object of the present invention is to provide an anti-bacterial touch panel and the manufacturing method for the same, the anti-bacterial touch panel by way of a chemical bonding through a silane coupling agent to form a bond between a glass substrate of the anti-bacterial touch panel and an anti-bacterial layer which is made of nano-antibacterial materials. The total thickness of the anti-bacterial layer and a bonding layer on the anti-bacterial touch panel is of a molecular level, thus, the size and optical properties of the anti-bacterial touch panel will not be affected.

To achieve the above object, the present invention provides a method for manufacturing an anti-bacterial touch panel, and the method includes the steps of (a) providing the glass substrate for the anti-bacterial touch panel, (b) coating a solution containing the silane coupling agent onto a surface of the glass substrate of the anti-bacterial touch panel, where user's fingers often touch, for forming the bonding layer, and (c) coating a solution containing the nano-antibacterial materials onto the bonding layer for forming the anti-bacterial layer.

In one exemplary embodiment of the present invention, the silane coupling agent includes (3-aminopropyl)triethoxysilane or aminopropyltrimethoxysilane.

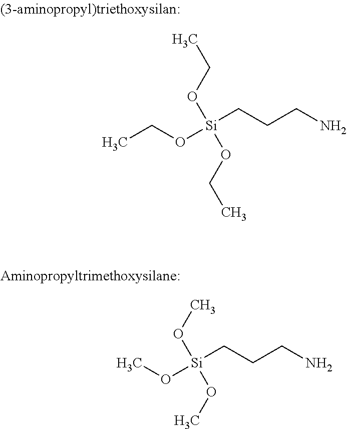

In one exemplary embodiment of the present invention, the silane coupling agent weight ratio in a solution containing the silane coupling agent is 0.5% to 2% of the total weight of the solution.

In one exemplary embodiment of the present invention, the solution containing the silane coupling agent further includes an organic solvent.

In one exemplary embodiment of the present invention, the organic solvent includes an ethanol, and concentration of the ethanol is 99%.

In one exemplary embodiment of the present invention, the nano-antibacterial materials comprise zinc oxide (ZnO), titanium dioxide (TiO₂), copper (Cu), gold (Au), silver (Ag), or clay.

In one exemplary embodiment of the present invention, a particle size of the nano-antibacterial materials is in a range of 1 nm to 100 nm.

In one exemplary embodiment of the present invention, nanoparticle structures of the nano-antibacterial materials are a group consisting of globes, sheets, rods, and tubes.

In one exemplary embodiment of the present invention, method of the coating includes dip coating, spin coating, and spray coating.

Furthermore, the present invention provides an anti-bacterial touch panel includes: a touch panel includes a glass substrate; the anti-bacterial layer is made of nano-antibacterial materials, and the anti-bacterial layer is formed on a surface of the glass substrate of the anti-bacterial touch panel where user's fingers often touch; and a bonding layer which is formed between the glass substrate and the anti-bacterial layer, the bonding layer by way of a chemical bonding bonds the silane coupling agent and the bonding layer.

The anti-bacterial touch panel and the manufacturing method for the same of the present invention includes the bond between the glass substrate of the anti-bacterial touch panel and the anti-bacterial layer made of the nano-antibacterial materials by a chemical bonding through the silane coupling agent than prior art. The total thickness of the anti-bacterial layer and the bonding layer on the anti-bacterial touch panel is of the molecular level, thus, the size and the optical properties of the anti-bacterial touch panel will not be affected.

### BRIEF DESCRIPTION OF THE DRAWINGS

The FIGURE is a flow chart of a method according to the present invention for manufacturing an anti-bacterial touch panel.

### DETAILED DESCRIPTION OF THE PREFERRED EMBODIMENTS

To describe the technical matters, structural features, achieved objects and effects, an embodiment is described in detail with reference to the accompanying drawings as follows.

Please refer to the FIGURE, which is a flow chart of a method according to the present invention for manufacturing an anti-bacterial touch panel, and the method includes steps S11-S15.

In step S11, provided is a glass substrate for the anti-bacterial touch panel.

In step S12, clean a surface of the glass substrate by an acid solution.

In step S13, a solution containing a silane coupling agent is coated onto the surface of the glass substrate of the anti-bacterial touch panel where user's fingers often touch.

In step S14, a solution containing nano-antibacterial materials is coated onto a surface of the glass substrate with the silane coupling agent.

In step S15, the glass substrate with the nano-antibacterial materials is dried.

In the method for manufacturing the anti-bacterial touch panel of the present invention, the acid solution solute is one selected from a group consisting of sulfuric acid (H₂SO₄), nitric acid (HNO₃), hydrochloric acid (HCl), and acetic acid (HCH₂COOH).

In the method for manufacturing the anti-bacterial touch panel of the present invention, the silane coupling agent weight ratio in a solution containing the silane coupling agent is 0.5% to 2% of the total weight of the solution, and the remaining is ethanol. The silane coupling agent is selected from (3-aminopropyl)triethoxysilane or aminopropyltrimethoxysilane.

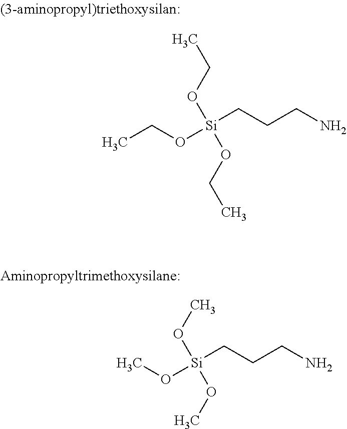

In the method for manufacturing the anti-bacterial touch panel of the present invention, the solution containing the nano-antibacterial materials has a concentration in a range of 500 ppm to 1000 ppm. The nano-antibacterial materials comprise zinc oxide (ZnO), titanium dioxide (TiO₂), copper (Cu), gold (Au), silver (Ag), or clay. A particle size of the nano-antibacterial materials is in a range of 1 nm to 100 nm, and nanoparticle structures of the nano-antibacterial materials are a group consisting of globes, sheets, rods, and tubes.

In the method for manufacturing the anti-bacterial touch panel of the present invention, the coating method includes dip coating, spin coating, and spray coating.

### Example 1

In one embodiment of the present invention, a glass substrate of a touch panel is first immersed into an 18 M sulfuric acid solution for 1 minute, followed by a deionized water rinse to remove residual acidic solution on the surface of the glass substrate. After cleaning the glass substrate is immersed into a 1% w/w (3-aminopropyl)triethoxysilane solution, and reacted for 30-60 minutes at room temperature, followed by the deionized water and an ethanol rinse to remove residual (3-aminopropyl)triethoxysilane solution on the surface of the glass substrate. After reacting the glass substrate is immersed into a 1000 ppm nanosilver solution, and reacted for 12-24 hours at room temperature, followed by the deionized water and the ethanol rinse to remove residual nanosilver solution on the surface of the glass substrate. Final, obtaining an anti-bacterial touch panel having high transparency by drying at room temperature. An antibacterial rate of the anti-bacterial touch panel of the embodiment is 99.999% according to inspection specification of JIS Z2801 to perform anti-bacterial test of Escherichia coli (strain: ATCC 8739). The test is conducted by Intertek Testing Services Taiwan Ltd.

### Example 2

In another embodiment of the present invention, a glass substrate of a touch panel is first immersed into an 18 M sulfuric acid solution for 1 minute, followed by a deionized water rinse to remove residual acidic solution on the surface of the glass substrate. After cleaning the glass substrate is immersed into a 0.5% w/w (3-aminopropyl)triethoxysilane solution, and reacted for 30-60 minutes at room temperature, followed by the deionized water and an ethanol rinse to remove residual (3-aminopropyl)triethoxysilane solution on the surface of the glass substrate. After reacting the glass substrate is immersed into a 500 ppm nanosilver solution, and reacted for 1-4 hours at room temperature, followed by the deionized water and the ethanol rinse to remove residual nanosilver solution on the surface of the glass substrate, and drying for 30-60 minutes at 80° C. Final, obtaining an anti-bacterial touch panel having high transparency by drying for 30-60 minutes at 80° C. An antibacterial rate of the anti-bacterial touch panel of the embodiment is 99.999% according to inspection specification of JIS Z2801 to perform anti-bacterial test of Escherichia coli (strain: ATCC 8739). The test is conducted by Intertek Testing Services Taiwan Ltd.

As mentioned above, the anti-bacterial touch panel and the manufacturing method for the same of the present invention includes a bond between the glass substrate of the anti-bacterial touch panel and an anti-bacterial layer made of the nano-antibacterial materials by a chemical bonding through the silane coupling agent. The total thickness of the anti-bacterial layer and the bonding layer on the anti-bacterial touch panel is of a molecular level, thus, the size and optical properties of the anti-bacterial touch panel will not be affected.

It should be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method for manufacturing an anti-bacterial touch panel, comprising:
providing a glass substrate for the anti-bacterial touch panel;
coating a solution containing a silane coupling agent onto a surface of the glass substrate of the anti-bacterial touch panel where often touched by user's fingers for forming a bonding layer; and
coating a solution containing nano-antibacterial materials onto the bonding layer to form an anti-bacterial layer.

2. The method of claim 1, wherein the silane coupling agent comprises (3-aminopropyl)triethoxysilane or aminopropyltrimethoxysilane.

3. The method of claim 1, wherein the silane coupling agent weight ratio in a solution containing the silane coupling agent is 0.5% to 2% of the total weight of the solution.

4. The method of claim 3, wherein the solution containing the silane coupling agent further comprises an organic solvent.

5. The method of claim 4, wherein the organic solvent comprises ethanol.

6. The method of claim 1, wherein the nano-antibacterial materials comprise zinc oxide, titanium dioxide, copper, gold, silver, or clay.

7. The method of claim 1, wherein a particle size of the nano-antibacterial materials is in a range of 1 nm to 100 nm.

8. The method of claim 1, wherein nanoparticle structures of the nano-antibacterial materials are a group consisting of globes, sheets, rods, and tubes.

9. The method of claim 1, wherein a coating method comprises dip coating, spin coating, or spray coating.

10. An anti-bacterial touch panel, comprising:
a touch panel having a glass substrate;
an anti-bacterial layer having nano-antibacterial materials, the anti-bacterial layer being formed onto a surface of the glass substrate of the anti-bacterial touch panel where user's fingers often touch; and
a bonding layer formed between the glass substrate and the anti-bacterial layer by a way of chemical bonding the silane coupling agent and the anti-bacterial layer of the glass substrate.
